(19) United States
(12) Patent Application Publication
(10) Pub. No.: US 2023/0262640 A1
(43) Pub. Date: Aug. 17, 2023

(54) METHOD AND APPARATUS FOR PROVIDING NETWORK SLICE SERVICES THROUGH MULTI-OPERATOR NETWORKS IN WIRELESS COMMUNICATION SYSTEM

(71) Applicant: LG Electronics Inc., Seoul (KR)

(72) Inventor: Sung Duck CHUN, Seoul (KR)

(21) Appl. No.: 18/014,668

(22) PCT Filed: Jun. 17, 2021
(86) PCT No.: PCT/KR2021/007601

§ 371 Date: Jan. 5, 2023

(30) Foreign Application Priority Data
Jul. 21, 2020 (KR) 10-2020-0090409

(51) Int. Cl. H04W 60/00; H04W 48/08; H04W 48/18; H04W 76/11

(52) U.S. Cl. CPC H04W 60/005; H04W 48/08; H04W 48/18; H04W 76/11

(57) ABSTRACT

In order to provide network slice services through multiple operator networks in a wireless communication system, an operation method of a user equipment (UE) comprises transmitting a first request message requesting registration for a first slice to a first core network node of a first network, receiving a first response message accepting registration for the first slice from the first core network node, transmitting a second request message requesting registration for a second slice to a second core network node of a second network, and receiving a second response message accepting registration for the second slice from the second core network node.

### TECHNICAL FIELD

The following description relates to a wireless communication system, and, more particularly, to a method and an apparatus for providing network slice services through multiple operator networks in a wireless communication system.

### BACKGROUND ART

3rd generation partnership project (3GPP) long-term evolution (LTE) is a technology for enabling high-speed packet communications, Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

### DISCLOSURE

### Technical Problem

The present disclosure relates to an apparatus and method for providing network slice services through multiple operator networks in a wireless communication system.

The present disclosure relates to an apparatus and method for registering a terminal in a plurality of operator networks in a wireless communication system.

The technical objects to be achieved in the present disclosure are not limited to the above-mentioned technical objects, and other technical objects that are not mentioned may be considered by those skilled in the art through the embodiments described below

### Technical Solution

As an example of the present disclosure, an operation method of a user equipment: (UE) in a wireless communication system may comprise transmitting a first request message requesting registration for a first slice to a first core network node of a first network, receiving a first response message accepting registration for the first slice from the first core network node, transmitting a second request message requesting registration for a second slice to a second core network node of a second network, and receiving a second response message accepting registration for the second slice from the second core network node.

As an example of the present disclosure, an operation method of an apparatus for providing a unified data management (UDM) function in a wireless communication system may comprise receiving a request message including information related to a slice to be provided to a user equipment (UE) registered with a first network from a second network, updating context of the UE such that the UE has registration on the first network and registration on the second network, and transmitting a response message indicating acceptance of registration on the second network.

As an example of the present disclosure, a user equipment (UE) in a wireless communication system, the UE comprises a transceiver and at least one processor coupled to the transceiver. The at least one processor may configure to transmit a first request message requesting registration for a first slice to a first core network node of a first network, to receive a first response message accepting registration for the first slice from the first core network node, to transmit a second request message requesting registration for a second slice to a second core network node of a second network, and to receive a second response message accepting registration for the second slice from the second core network node.

As an example of the present disclosure, an apparatus for providing a unified data management (UDM) function in a wireless communication system comprises a transceiver and at least one processor coupled to the transceiver. The processor may configure to receive a request message including information related to a slice to be provided to a user equipment (UE) registered with a first network from a second network, to update context of the UE such that the UE has registration on the first network and registration on the second network, and to transmit a response message indicating acceptance of registration on the second network.

An apparatus may comprise at least one processor and at least one computer memory coupled to the at least one processor and configured to store an instruction indicating operations as being executed by the at least one processor. The operations may control the apparatus to transmit a first request message requesting registration for a first slice to a first core network node of a first network, to receive a first response message accepting registration for the first slice from the first core network node, to transmit a second request message requesting registration for a second slice to a second core network node of a second network and to receive a second response message accepting registration for the second slice from the second core network node.

A non-transitory computer-readable medium storing at least one instruction may comprise the at least one instruction executable by a processor. The at least one instruction may control the apparatus to transmit a first request message requesting registration for a first slice to a first core network node of a first network, to receive a first response message accepting registration for the first slice from the first core network node, to transmit a second request message requesting registration for a second slice to a second core network node of a second network and to receive a second response message accepting registration for the second slice from the second core network node.

The above-described aspects of the present disclosure are only a part of the preferred embodiments of the present disclosure, and various embodiments reflecting technical features of the present disclosure may be derived and understood by those skilled in die art on the basis of the detailed description of the present disclosure provided below.

### Advantageous Effects

The following effects may be produced by embodiments based on the present disclosure.

According to the present disclosure, a terminal may use various network slice services by simultaneously using a plurality of operator networks.

Effects obtained in the present disclosure are not limited to the above-mentioned effects, and other effects not mentioned above may be clearly derived and understood by those skilled in the art, to which a technical configuration of the present disclosure is applied, from the following description of embodiments of the present disclosure. That is, effects, which are not intended when implementing a configuration described in the present disclosure, may also be derived by those skilled in the art from the embodiments of the present disclosure.

### DESCRIPTION OF DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates an example of a communication system applicable to the present disclosure.

FIG. 2 illustrates an example of wireless devices applicable to the present disclosure.

FIG. 3 illustrates an example of a wireless device applicable to the present disclosure.

FIGS. 4A and 4B illustrate an example of protocol stacks in a 3GPP based wireless communication system applicable to the present disclosure.

FIG. 5 illustrates an example of the overall architecture of an NG-RAN applicable to the present disclosure.

FIG. 6 illustrates an interface protocol structure for F1-C applicable to the present disclosure.

FIG. 7 illustrates an example of a general architecture of a 5th generation (5G) system applicable to the present disclosure.

FIG. 8 illustrates an example of a core network applicable to the present disclosure.

FIG. 9 illustrates an example of architecture for implementing the concept of network slicing applicable to the present disclosure.

FIG. 10 illustrates another example of architecture for implementing the concept of network slicing applicable to the present disclosure.

FIG. 11 illustrates the concept of providing a plurality of network slice services in a wireless communication system according to an embodiment of the present disclosure.

FIGS. 12A and 12B illustrate an example of a procedure for registration between a terminal and networks in a wireless communication system according to an embodiment of the present disclosure.

FIG. 13 illustrates an example of a procedure for network registration in a wireless communication system according to an embodiment of the present disclosure.

FIG. 14 illustrates an example of a procedure for managing information related to network registration in a wireless communication system according to an embodiment of the present disclosure.

### MODE FOR INVENTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E, UTRA. 3GPP LTE employs OFDMA in DL and SC-FDMA in UL. Evolution of 3GPP LTE includes LTE-A (advanced), LTE-A Pro, and/or 5G NR (new radio).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A. B, C” may mean “A, B or C”.

In the present disclosure, “at least one of A and B” may mean “only A”, “only B” or “both A and B”. In addition, the expression at least one of A or B″ or at least one of A and/or B″ in the present disclosure may be interpreted as same as “at least one of A and B”.

In addition, in the present disclosure, “at least one of A. B and C” may mean “only A”, “only B”, “only C”, or “any combination of A, B and C”. In addition, “at least one of A, B or C” or “at least one of A, B and/or C” may mean at least one of A, B and C″.

Also, parentheses used in the present disclosure may mean “for example”. In detail, when it is shown as “control information (PDCCH)”, “PDCCH.” may be proposed as an example of “control information”. In other words, “control information” in the present disclosure is not limited to “PDCCH”, and “PDDCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

Communication System Applicable to the Disclosure

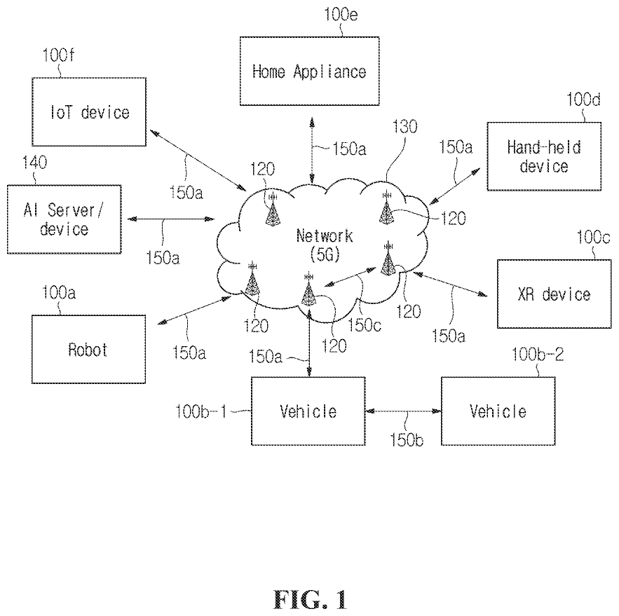

FIG. 1 illustrates an example of a communication system applicable to the present disclosure.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and healing controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability_ and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system includes wireless devices 110a to 110f, base stations (BSs) 120, and a network 130. Although FIG. 1 illustrates a 5G network as an example of the network of the communication system 1, the implementations of the present disclosure are not limited to the 5G system, and can be applied to the future communication system beyond the 5G system.

The BSs 120 and the network 130 may be implemented as wireless devices and a specific wireless device may operate as a BS/network node with respect to other wireless devices.

The wireless devices 110a to 110f represent devices performing communication using radio access technology (RAT) (e.g., 5G new RAT (NR)) or LTE) and may be referred to as communication/radio/5G devices. The wireless devices 110a to 110f may include, without being limited to, a robot 110a, vehicles 110b-1 and 110b-2, an extended reality (XR) device 110c, a hand-held device 110d, a home appliance 110e, an IoT device 110f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (MID), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 110a to 110f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 110a to 110f may be connected to the network 130 via the BSs 120. An AI technology may be applied to the wireless devices 110a to 110f and the wireless devices 110a to 110f may be connected to the AI server 400 via the network 130. The network 130 may be configured using a 3G network, a 4G (e.g., LTE) network, a 5G (e.g, NR) network, and a beyond-5G network. Although the wireless devices 110a to 110f may communicate with each other through the BSs 120/network 130, the wireless devices 110a to 110f may perform direct communication (e.g., sidelink communication) with each other without passing through the BSs 120/network 130. For example, the vehicles 110b-1 and 110b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 110a to 110f.

Wireless communication/connections 150a, 150b and 150c may be established between the wireless devices 110a to 110f and/or between wireless device 110a to 110f and BS 120 and/or between BSs 120, Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 110a to 110f and the BSs 120/the wireless devices 110a to 110f may transmit/receive radio signals to/from each other through the wireless communication/connections 150a, 150b and 150c. For example, the wireless communication/connections 150a, 150b and 150c may transmit/receive signals through various physical channels, To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through computer graphic (CG) images. AR technology provides a virtual CO image on top of a real object image. MR technology is a CO technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities.

Radio Resource Structure

NR supports multiples numerologies (and/or multiple subcarrier spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

An NR frequency hand may be defined as two different types (FR1 and FR2) of frequency ranges. The values of the frequency ranges may be changed (or varied), and, for example, frequency ranges corresponding to the FR1 and FR2 may be 450 MHz-6000 MHz and 24250 MHz-52600 MHz, respectively. Further, supportable SCSs is 15, 30 and 60 kHz for the FR1 and 60, 120, 240 kHz for the FR2. Among the frequency ranges that are used in an NR system, FR1 may mean a “sub 6 GHz range”, and FR2 may mean an “above 6 GHz range” and may also be referred to as a millimeter wave (mmW).

As described above, the values of the frequency ranges in the NR system may be changed (or varied). For example, comparing to examples for the frequency ranges described above, FR1 may be defined to include a band within a range of 410 MHz to 7125 MHz. More specifically, FR1 may include a frequency band of 6 GHz (or 5850, 5900, 5925 MHz, and so on) and higher. For example, a frequency band of 6 GHz (or 5850, 5900, 5925 MHz, and so on) and higher being included in FR1 mat include an unlicensed band. The unlicensed band may be used for diverse purposes, e.g., the unlicensed band for vehicle-specific communication (e.g., automated driving).

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NM1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) ELF, Cat 0, 2) LTE Cat M1, 3) LTE Cat M2, 4) LTE non-bandwidth limited (non-BL), 5) LTE-MEC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANS) associated with small/low-power digital communication based on various specifications such as IEEE 802.15.4 and may be called various names.

Device Applicable to the Disclosure

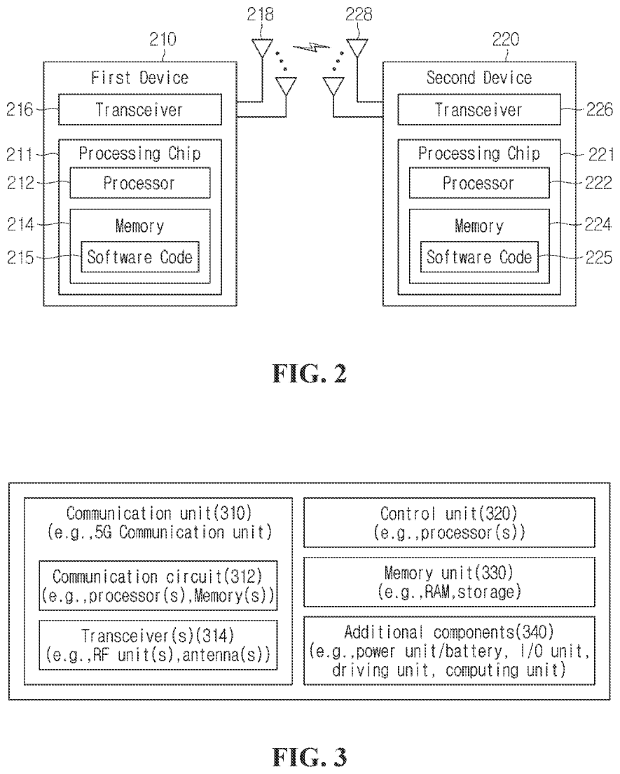

FIG. 2 illustrates an example of wireless devices applicable to the present disclosure.

Referring to FIG. 2, a first wireless device 210 and a second wireless device 220 may transmit/receive radio signals to/from an external device through a variety of RATs (e.g., LTE and NR).

In FIG. 2, {the first wireless device 210 and the second wireless device 220} may correspond to at least one of {the wireless device 110a to 110f and the BS 220}, {the wireless device 110a to 110f and the wireless device 110a to 110f} and/or {the BS 220 and the BS 220} of FIG. 1.

The first wireless device 210 may include at least one transceiver, such as a transceiver 216, at least one processing chip, such as a processing chip 211, and/or one or more antennas 218.

The processing chip 211 may include at least one processor, such a processor 212, and at least one memory, such as a memory 214. It is exemplarily shown in FIG. 2 that the memory 214 is included in the processing chip 211. Additional and/or alternatively, the memory 214 may be placed outside of the processing chip 211.

The processor 212 may control the memory 214 and/or the transceiver 216 and may be configured to implement the descriptions, functions, procedures, suggestions, methods and/or operational flowcharts described in the present disclosure. For example, the processor 212 may process information within the memory 214 to generate first information/signals and then transmit radio signals including the first information/signals through the transceiver 216. The processor 212 may receive radio signals including second information/signals through the transceiver 216 and then store information obtained by processing the second information/signals in the memory 214.

The memory 214 may be operably connectable to the processor 212. The memory 214 may store various types of information and/or instructions. The memory 214 may store a software code 215 which implements instructions that, when executed by the processor 212, perform the descriptions, functions, procedures, suggestions, methods and/or operational flowcharts disclosed in the present disclosure. For example, the software code 215 may implement instructions that, when executed by the processor 212, perform the descriptions, functions, procedures, suggestions, methods and/or operational flowcharts disclosed in the present disclosure. For example, the software code 215 may control the processor 212 to perform one or more protocols. For example, the software code 215 may control the processor 212 to perform one or more layers of the radio interface protocol.

Herein, the processor 212 and the memory 214 may be a part of a communication modem/circuit/chip designed to implement RAT (e.g., LTE or NR). The transceiver 216 may be connected to the processor 212 and transmit and/or receive radio signals through one or more antennas 218. Each of the transceiver 216 may include a transmitter and/or a receiver. The transceiver 216 may be interchangeably used with radio frequency (RF) unit(s). In the present disclosure, the first wireless device 210 may represent a communication modem/circuit/chip.

The second wireless device 220 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be configured to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 216 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 220 may represent a communication modem/circuit/chip.

Hereinafter, hardware elements of the wireless devices 210 and 220 will be described more specifically. One or more protocol layers may be implemented by, without being limited to, one or more processors 212 and 202. For example, the one or more processors 212 and 202 may implement one or more layers (e.g., functional layers such as physical (PRY) layer, media access control (MAC) layer, radio link control (RLC) layer, packet data convergence protocol (PDCP) layer, radio resource control (RRC) layer, and service data adaptation protocol (SDAP) layer). The one or more processors 212 and 202 may generate one or more protocol data units (PDUs) and/or one or more service data unit (SDUs) according to the descriptions, functions, procedures, suggestions, methods and/or operational flowcharts disclosed in the present disclosure. The one or more processors 212 and 202 may generate messages, control information, data, or information according to the descriptions, functions, procedures, suggestions, methods and/or operational flowcharts disclosed in the present disclosure. The one or more processors 212 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 216 and 206. The one or more processors 212 and 202 may receive the signals (e.g., baseband signals) from the one or more transceivers 216 and 206 and acquire the PDUs, SDUs, messages, control information, data, or information according to the descriptions, functions, procedures, suggestions, methods and/or operational flowcharts disclosed in the present disclosure.

The one or more processors 212 and 202 may be referred to as controllers, microcontrollers, microprocessors, or microcomputers. The one or more processors 212 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 212 and 202. The descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 212 and 202 or stored in the one or more memories 214 and 204 so as to be driven by the one or more processors 212 and 202. The descriptions, functions, procedures, suggestions, methods and/or operational flowcharts disclosed in the present disclosure may be implemented using firmware or software in the form of code, commands, and/or a set of commands.

The one or more memories 214 and 204 may be connected to the one or more processors 212 and 202 and store various types of data, signals, messages, information, programs, code, instructions, and/or commands. The one or more memories 214 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 214 and 204 may be located at the interior and/or exterior of the one or more processors 212 and 202. The one or more memories 214 and 204 may be connected to the one or more processors 212 and 202 through various technologies such as wired or wireless connection.

The one or more transceivers 216 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 216 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 216 and 206 may be connected to the one or more processors 212 and 202 and transmit and receive radio signals. For example, the one or more processors 212 and 202 may perform control so that the one or more transceivers 216 and 206 may transmit user data, control information, or radio signals to one or more other devices. The one or more processors 212 and 202 may perform control so that the one or more transceivers 216 and 206 may receive user data, control information, or radio signals from one or more other devices.

The one or more transceivers 216 and 206 may be connected to the one or more antennas 218 and 208 and the one or more transceivers 216 and 206 may be configured to transmit and receive user data, control information, and/or radio signals/channels, mentioned in the descriptions, functions, procedures, suggestions, methods and/or operational flowcharts disclosed in the present disclosure, through the one or more antennas 218 and 208. In the present disclosure, the one or more antennas 218 and 208 may be a plurality of physical antennas or a plurality of logical antennas (e.g., antenna ports).

The one or more transceivers 216 and 206 may convert received user data, control information, radio signals/channels, etc., from RF band signals into baseband signals in order to process received user data, control information, radio signals/channels, etc., using the one or more processors 212 and 202. The one or more transceivers 216 and 206 may convert the user data, control information, radio signals/channels, etc., processed using the one or more processors 212 and 202 from the base band signals into the RF band signals. To this end, the one or more transceivers 216 and 206 may include (analog) oscillators and/or filters. For example, the one or more transceivers 216 and 206 can up-convert OFDM baseband signals to OFDM signals by their (analog) oscillators and/or filters under the control of the one or more processors 212 and 202 and transmit the up-converted OFDM signals at the carrier frequency. The one or more transceivers 216 and 206 may receive OFDM signals at a carrier frequency and down-convert the OFDM signals into OFDM baseband signals by their (analog) oscillators and/or filters under the control of the one or more processors 212 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 210 acts as the UE, and the second wireless device 220 acts as the BS. For example, the processor(s) 212 connected to, mounted on or launched in the first wireless device 210 may be configured to perform the UE behavior according to an implementation of the present disclosure or control the transceiver(s) 216 to perform the UE behavior according to an implementation of the present disclosure. The processor(s) 202 connected to, mounted on or launched in the second wireless device 220 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

FIG. 3 illustrates an example of a wireless device applicable to the present disclosure.

The wireless device may be implemented in various forms according to a use-case/service (refer to FIG. 1).

Referring to FIG. 3, wireless devices may correspond to the wireless devices of FIG. 2 and may be configured by various elements, components, units/portions, and/or modules. For example, each of the wireless devices may include a communication unit 310, a control unit 320, a memory unit 330, and additional components 340. The communication unit 310 may include a communication circuit 312 and transceiver(s) 314. For example, the communication circuit 312 may include the one or more processors 302 and 202 of FIG. 2 and/or the one or more memories 304 and 204 of FIG. 2. For example, the transceivers) 314 may include the one or more transceivers 106 and 206 of FIG. 2 and/or the one or more antennas 108 and 208 of FIG. 2. The control unit 320 is electrically connected to the communication unit 310, the memory unit 330, and the additional components 340 and controls overall operation of each of the wireless devices. For example, the control unit 320 may control an electric/mechanical operation of each of the wireless devices based on programs/code/commands/information stored in the memory unit 330. The control unit 320 may transmit the information stored in the memory unit 330 to the exterior (e.g., other communication devices) via the communication unit 310 through a wireless/wired interface or store, in the memory unit 330, information received through the wireless/wired interface from the exterior (e.g., other communication devices) via the communication unit 310.

The additional components 340 may be variously configured according to types of the wireless devices. For example, the additional components 340 may include at least one of a power unit/battery, input/output (I/O) unit (e.g., audio I/O port, video I/O port), a driving unit, and a computing unit. The wireless devices may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1) a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices may be used in a mobile or fixed place according to a use-example/service.

In FIG. 3, the entirety of the various elements, components, units/portions, and/or modules in the wireless devices may be connected to each other through a wired interface or at least a part thereof may be wirelessly connected through the communication unit 310. For example, in each of the wireless devices, the control unit 320 and the communication unit 310 may be connected by wire and the control unit 320 and first units (e.g., 330 and 340) may be wirelessly connected through the communication unit 310. Each element, component, unit/portion, and/or module within the wireless devices may further include one or more elements. For example, the control unit 320 may be configured by a set of one or more processors. As an example, the control unit 320 may be configured by a set of a communication control processor, an application processor (AP), an electronic control unit (ECU), a graphical processing unit, and a memory control processor. As another example, the memory unit 330 may be configured by a RAM, a DRAM, a ROM, a flash memory, a volatile memory, a non-volatile memory, and/or a combination thereof.

Protocol Applicable to the Disclosure

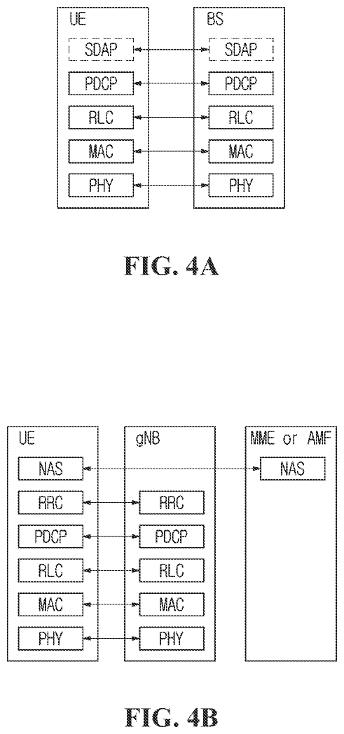

FIGS. 4A and 4B illustrate an example of protocol stacks in a 3GPP based wireless communication system applicable to the present disclosure.

In particular, FIG. 4A illustrates an example of a radio interface user plane protocol stack between a UE and a BS and FIG. 4B illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4A, the user plane protocol stack may be divided into Layer 1 (i.e., a PHY layer) and Layer 2. Referring to FIG. 4B, the control plane protocol stack may be divided into Layer 1 (i.e., a PHY layer), Layer 2, Layer 3 (e.g., an RRC layer), and a non-access stratum (AS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point hi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer; UE cell selection and reselection and control of cell selection and reselection, inter-RAT mobility); QoS management functions; UE measurement reporting and control of the reporting; detection of and recovery from radio link failure; NAS message transfer to/from NAS from/to UE,

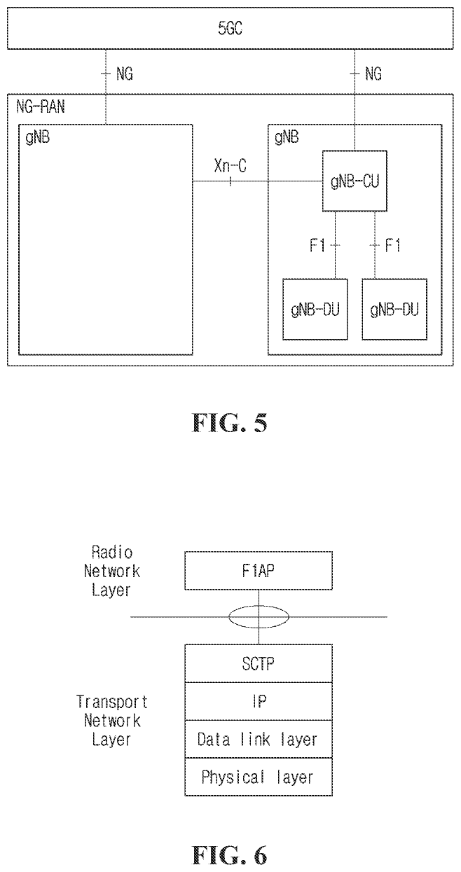

FIG. 5 illustrates an example of the overall architecture of an NG-RAN applicable to the present disclosure.

Referring to FIG. 5, a gNB may include a gNB-CU (hereinafter, gNB-CU may be simply referred to as CU) and at least one gNB-DU (hereinafter, gNB-DU may be simply referred to as DU).

The gNB-CLI is a logical node hosting RRC, SDAP and PDCP protocols of the gNB or an RRC and PDCP protocols of the en-gNB. The gNB-CU controls the operation of the at least one gNB-DU.

The gNB-DU is a logical node hosting RLC, MAC, and physical layers of the gNB or the en-gNB. The operation of the gNB-DU is partly controlled by the gNB-CU. One gNB-DU supports one or multiple cells. One cell is supported by only one gNB-DU.

The gNB-CU and gNB-DU are connected via an F1 interface. The gNB-CU terminates the F1 interface connected to the gNB-DU. The gNB-DU terminates the F1 interface connected to the gNB-CU. One gNB-DU is connected to only one gNB-CU. How-ever, the gNB-DU may connected to multiple gNB-CUs by appropriate implementation. The F1 interface is a logical interface. For NG-RAN, the NG and Xn-C interfaces for a gNB consisting of a gNB-CU and gNB-DUs, terminate in the gNB-CU. For E-UTRAN-NR dual connectivity (EN-DC), the S U and X2-C interfaces for a gNB consisting of a gNB-CU and gNB-DUs, terminate in the gNB-CU. The gNB-CU and connected gNB-DUs are only visible to other gNBs and the 5GC as a gNB.

Functions of the F1 interface includes F1 control (F1-C) functions as follows.

(1) F1 Interface Management Function

The error indication function is used by the gNB-DU or gNB-CU to indicate to the gNB-CU or gNB-DU that an error has occurred.

The reset function is used to initialize the peer entity after node setup and after a failure event occurred. This procedure can be used by both the gNB-DU and the gNB-CU.

The F1 setup function allows to exchange application level data needed for the gNB-DU and gNB-CU to interoperate correctly on the F1 interface. The F1 setup is initiated by the gNB-DU.

The gNB-CU configuration update and gNB-DLI configuration update functions allow to update application level configuration data needed between gNB-CU and gNB-DU to interoperate correctly over the F1 interface, and may activate or deactivate cells.

The F1 setup and gNB-DU configuration update functions allow to inform the single network slice selection assistance information (S-NSSAI) supported by the gNB-DU.

The F1 resource coordination function is used to transfer information about frequency resource sharing between gNB-CU and gNB-DU.

(2) System Information Management Function

Scheduling of system broadcast information is carried out in the gNB-DU. The gNB-DU is responsible for transmitting the system information according to the scheduling parameters available.

The gNB-DU is responsible for the encoding of NR master information block (MIB). In case broadcast of system information block type-1 (SIB1) and other SI messages is needed, the gNB-DU is responsible for the encoding of SIB1 and the gNB-CU is responsible for the encoding of other SI messages.

(3) F1 UE Context Management Function

The F1 UE context management function supports the establishment and modification of the necessary overall UE context.

The establishment of the F1 UE context is initiated by the gNB-CU and accepted or rejected by the gNB-DU based on admission control criteria (e.g., resource not available).

The modification of the F1 UE context can be initiated by either gNB-CU or gNB-DU. The receiving node can accept or reject the modification. The F1 UE context management function also supports the release of the context previously established in the gNB-DU, The release of the context is triggered by the gNB-CU either directly or following a request received from the gNB-DU. The gNB-CU request the gNB-DU to release the UE Context when the UE enters RRC IDLE or RRC INACTIVE.

This function can be also used to manage DRBs and SRBs, i.e., establishing, modifying and releasing DRB and SRB resources. The establishment and modification of DRB resources are triggered by the gNB-CU and accepted/rejected by the gNB-DU based on resource reservation information and QoS information to be provided to the gNB-DU. For each DRB to be setup or modified, the S-NSSAI may be provided by gNB-CU to the gNB-DU the UE context setup procedure and the UE context modification procedure.

The mapping between QoS flows and radio bearers is performed by gNB-CU and the granularity of bearer related management over F1 is radio bearer level. For NG-RAN, the gNB-CU provides an aggregated DRB QoS profile and QoS flow profile to the gNB-DU, and the gNB-DU either accepts the request or rejects it with appropriate cause value. To support packet duplication for intra-gNB-DU carrier aggregation (CA), one data radio bearer should be configured with two GPRS tunneling protocol (GTP)-U tunnels between gNB-CU and a gNB-DU.

With this function, gNB-CU requests the gNB-DU to setup or change of the special cell (SpCell) for the UE, and the gNB-DU either accepts or rejects the request with appropriate cause value.

With this function, the gNB-CU requests the setup of the secondary cell(s) (SCell(s)) at the gNB-DU side, and the gNB-DU accepts all, some or none of the SCell(s) and replies to the gNB-CU. The gNB-CU requests the removal of the SCell(s) for the UE.

(4) RRC Message Transfer Function

This function allows to transfer RRC messages between gNB-CU and gNB-DU. RRC messages are transferred over F1-C. The gNB-CU is responsible for the encoding of the dedicated RRC message with assistance information provided by gNB-DU.

(5) Paging Function

The gNB-DU is responsible for transmitting the paging information according to the scheduling parameters provided.

The gNB-CU provides paging information to enable the gNB-DU to calculate the exact paging occasion (PO) and paging frame (PF). The gNB-CU determines the paging assignment (PA). The gNB-DU consolidates all the paging records for a particular PO, PF and PA, and encodes the final RRC message and broadcasts the paging message on the respective PO, PF in the PA.

(6) Warning Messages Information Transfer Function

This function allows to cooperate with the warning message transmission procedures over NG interface. The gNB-CU is responsible for encoding the warning related SI message and sending it together with other warning related information for the gNB-DU to broadcast over the radio interface,

FIG. 6 illustrates an interface protocol structure for F1-C applicable to the present disclosure.

A transport network layer (TNL) is based on Internet protocol (IP) transport, comprising a stream control transmission protocol (SCTP) layer on top of the IP layer. An application layer signaling protocol is referred to as an F1 application protocol (E1 AP).

Network Nodes Applicable to the Disclosure

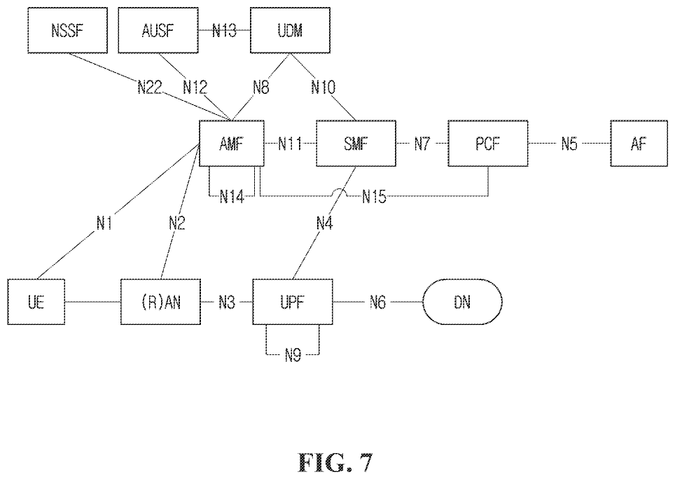

FIG. 7 illustrates an example of a general architecture of a 5th generation (5G) system applicable to the present disclosure.

Access and mobility management function (AMF) supports such functions as signaling between CN nodes for mobility between 3GPP access networks, termination of a radio access network (RAN) CP interface (N2), termination of NAS signaling (N1), registration management (registration area), idle mode UE reachability, support of network slicing, and SMF selection.

Some or all the functions of AMF may be supported in a single instance of one AMF.

Data network (DN) means an operator service, an Internet access or 3rd party service and the like, for example. DN transmits a downlink protocol data unit (PDU) or receives a PDU from a UPF, which UE transmits.

Policy control function (PCF) receives information on a packet flow from an application server and provides a function of determining policies like mobility management and session management.

Session management function (SMF) provides a session management function, and when UE has a plurality of sessions, each session may be managed by different SMFs.

Some or all the functions of SMF may be supported in a single instance of one SMF.

Unified data management (UDM) stores a user's subscription data, policy data and the like.

User plane function (UPF) forwards a downlink PDU, Which is received from a DN, to UE via (R)AN and forwards an uplink PDU, Which is received from UE, to a DN via (R)AN.

Application function (AF) operates with a 3GPP core network for service provision (e.g., for supporting functions like application effect on traffic routing, network capability exposure access, mutual operation with policy framework for policy control).

(Radio) access network ((R)AN) collectively refers to new radio access networks that support both evolved E-UTRA, which is an evolved version of 4G radio access, and a new radio (NR) access technology (e.g. eNB).

gNB supports functions for wireless resource management (that is, radio bearer control, radio admission control, connection mobility control, dynamic allocation of resources to UE in uplink/downlink (that is, scheduling)).

User equipment (UE) means a user device.

In a 3GPP system, a conception link connecting NFs in a 5G system is defined as a reference point.

N1 means a reference point between UE and AMF, N2 means a reference point between (R)AN and AMF, N3 means a reference point between (R)AN and UPF, N4 means a reference point between SMF and UPF, N6 means a reference point between UPF and a data network, N9 means a reference point between 2 core UPFs, N5 means a reference point between PCF and AF, N7 means a reference point between SMF and PCF, N24 means a reference point between PCF in a visited network and PCF in a home network, N8 means a reference point between UDM and AMF, N10 means a reference point between UDM and SMF, N11 means a reference point between AMF and SMF, N12 means a reference point between AMF and authentication server function (AUSF), N13 means a reference point between UDM and AUSF, N14 means a reference point between 2 AMFs, N15 means a reference point between PCF and AMF in the case of non-roaming scenario and a reference point between PCF in a visited network and AMF in the case of a roaming scenario, N16 means a reference point between 2 SMFs (in a roaming scenario, a reference point between SMF in a visited network and SMF in a home network), N17 means a reference point between AMF and 5G-equipment identify register (FIR), N18 means a reference point between AMF and unstructured data storage function (UDSF), N22 means a reference point between AMF and network slice selection function (NSSF), N23 means a reference point between PCF and network data analytics function (NWDAF), N24 means a reference point between NSSF and NWDAF, N27 means a reference point between network repository function (NRF) in a visited network and NRF in a home network, N31 means a reference point between NSSF in a visited network and NSSF in a home network, N32 means a reference point between security protection proxy (SEPP) in a visited network and SEPP in a home network, N33 means a reference point between network exposure function and AF, N40 means a reference point between SMF and charging function (CHF), and N50 means a reference point between AMF and circuit bearer control function (CBCF).

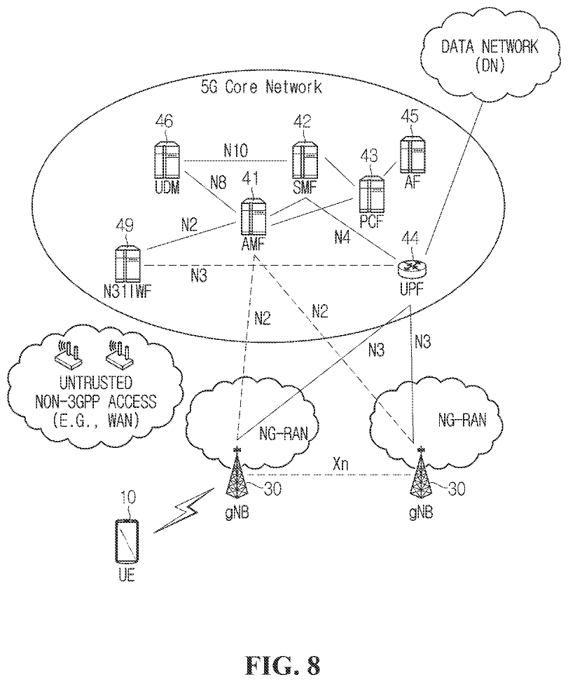

FIG. 8 illustrates an example of a core network applicable to the present disclosure. Referring to FIG. 8, the core network may include various components, and FIG. 8 shows an access and mobility management function (AMF), a session management function (SMF), a policy control function (PCF), and a user plane function (UPF), an application function (AF), a unified data management (UDM), and a non-3GPP interworking function (N3IWF), which are some of the various components. A UE is connected to a data network via a UPF over a Next Generation Radio Access Network (NG-RAN). The UTE may also receive data services through entrusted non-3GPP access, e.g., a wireless local area network (WLAN). In order to connect the non-3GPP access to the core network, the N3IWF may be disposed.

Cell Selection/Reselection

In a mobile communication system, it is assumed that a terminal continuously moves and, accordingly, in order to maintain a radio period between a terminal and a base station in an optimal state, the terminal continuously performs a cell selection/reselection process. Details are described in standard documents such as 3GPP TS 38.304 16.0.0.

Network Slice

In a 3GPP system, network resources are virtualized for efficient use of network resources, and through this, multiple virtual networks may be constructed, and the virtual networks are referred to as network slices. A network slice is a combination of network nodes that have functions required to provide a specific service. A network node constituting a slice instance may be a node independent in terms of hardware or a logically independent node. Each slice instance may be composed of a combination of all nodes necessary to construct the entire network. In this case, one slice instance may provide a service to a UE alone.

A slice instance may be composed of a combination of some of nodes constituting a network. In this case, the slice instance may provide a service to the UE association with other existing network nodes, without providing a service to the UE alone in addition, a plurality of slice instances may provide a service to the UE in association with each other.

A slice instance is different from a dedicated core network in that all network nodes including a core network (CN) node and a RAN may be separated. In addition, a slice instance is simply different from a dedicated core network in that network nodes may be logically separated.

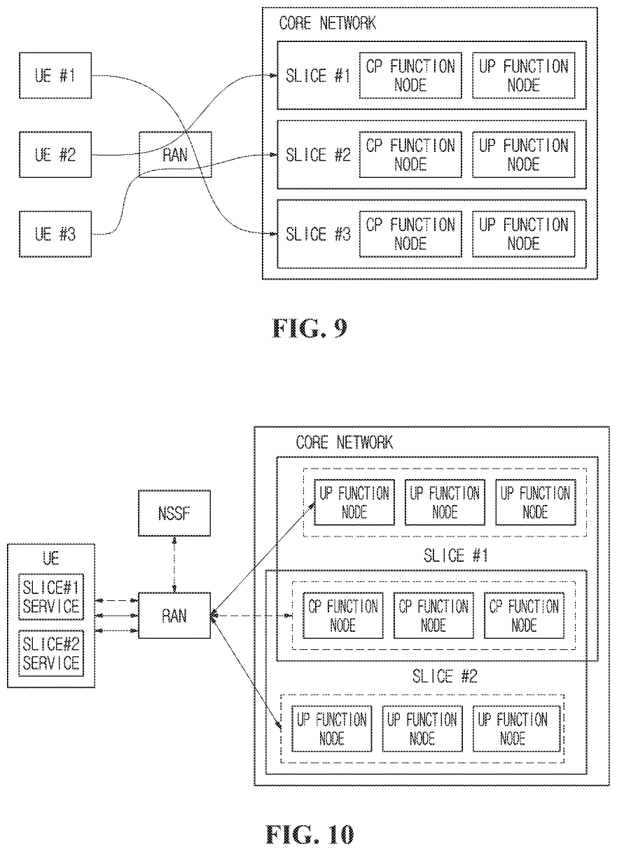

FIG. 9 illustrates an example of architecture for implementing the concept of network slicing applicable to the present disclosure. Referring to FIG. 9, a core network may be divided into several slice instances. Each slice instance may include one or more of a CP function node and an UP function node. Each UE may use a network slice instance suitable for its own service through a RAN. Unlike that shown in FIG. 9, each slice instance may share one or more of a CP function node and an UP function node with other slice instances.

FIG. 10 illustrates another example of architecture for implementing the concept of network slicing applicable to the present disclosure. Referring to FIG. 10, a plurality of UP function nodes are clustered, and a plurality of CP function nodes are clustered. In addition, slice instance #1 in the core network includes a first cluster of UP function nodes. In addition, slice instance #1 shares a cluster of CP function nodes with slice instance #2. Slice instance #2 includes a second cluster of UP functional nodes. NSSF selects a slice or instance that may accommodate the service of the UE. The UE may use service #1 through slice instance #1 selected by NSSF and use service #2 through slice instance #2 selected by NSSF.

As described above, most things may be connected through communication, and more convenient services may be provided. In the case of the existing 2G, 3G, and 4G systems, communication involving people was mainly used. For example, voice calls between people or scenarios in Which people directly browse the Internet or use services such as games were common. On the other hand, in the case of a 5G system, the scope of communication has diversified as various types of things are involved. For example, in the case of V2X, vehicles directly exchange information without human intervention. In the case of a smart factory, communication with extremely low-latency transfer characteristics is used for information exchange between machines. On the other hand, in the case of sensors installed in each home, for example, a temperature center, an air quality sensor, etc., a scenario in which data collected intermittently for a very long time is transmitted to a server or the like is applied.

Various network traffics are generated as described above and may be classified into categories such as mIoT, URLLC, eMBB, and V2X. Accordingly, in the structure of NSSAI, which is a network slice identifier, a slice type field called SD has been introduced, and through this, slice types such as mIoT, URLLC, eMBB, and V2X may be currently supported.

As mentioned above, many types of user data with different characteristics are currently being processed. Meanwhile, as the evolution of user devices continues, the user devices may also generate various types of data according to circumstances. For example, in the case of a vehicle, V2X traffic for traffic safety may be requested, but on the other hand, a user riding in a vehicle may consume eMBB traffic such as a video service. As another example, in the case of a general smartphone, users mainly consume audio/video/text media, but, in some cases, for example, if a user loses a smartphone and wants to track the location of the smartphone, traffic with characteristics of mIoT may be generated or used.

In addition, mobile communication services shall guarantee mobility of terminals due to their characteristics. For example, since a user may move to another country carrying a terminal owned by the user or a car may cross a border in the same way, the terminal installed in the car is also moved to another region. This means that each terminal crosses the service area of the mobile communication service operator that originally subscribed to the service, and each mobile communication service operator makes a contract with each other to support roaming services and the like. However, the type or quality of service provided by each mobile communication operator may be different in consideration of various factors such as characteristics of each region, frequency holding status, base station installation status, and performance of network equipment. Accordingly, when each mobile communication service operator makes a roaming contract with another mobile communication service operator, the mobile communication operators mutually determine which service is supported or requested.

Specific Embodiments of the Disclosure

The present disclosure relates to registration of a terminal, and relates to a technology for enabling a terminal to use a plurality of network slice services through a plurality of operator networks.

The present disclosure relates to registration of a terminal, and relates to a technology for enabling a terminal to use a plurality of network slice services through a plurality of operator networks.

Although a terminal subscribes to a plurality of different network slice services through a home public land mobile network (HPLMN), the terminal may not receive all network slice services subscribed to by one public land mobile network (PLMN). In this case, the terminal may not receive some of the subscribed network slice services. Accordingly, the present disclosure proposes a method of simultaneously providing network slice services to a terminal in a complex manner through a plurality of PLMNs.

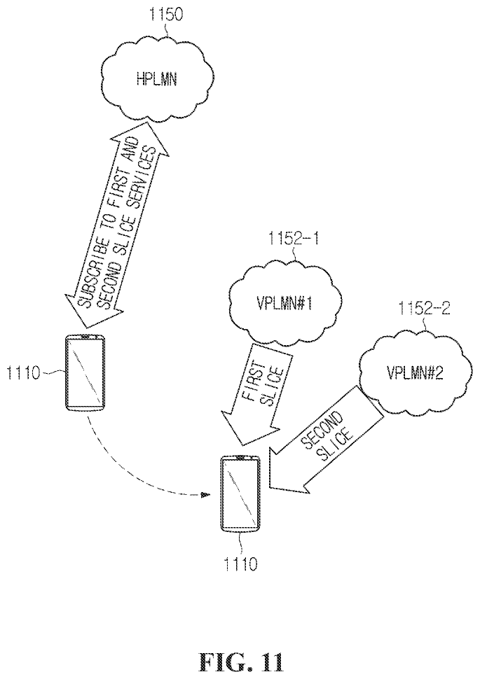

FIG. 11 illustrates the concept of providing a plurality of network slice services in a wireless communication system according to an embodiment of the present disclosure. FIG. 11 shows a situation where a plurality of network slice services is provided to a terminal.

Referring to FIG. 11, a terminal 1110 subscribes to a first slice service and a second slice service in a HPLMN 1150. Thereafter, the terminal 1110 may move to another area not serviced by the HPLMN 1150. Accordingly, the terminal 1110 may register with one of visited public land mobile networks (VPLMNs) 1152-1 and 1152-2 that provide a service in the corresponding area and use the service.

At this time, the terminal 1110 may want to use both the subscribed first and second slice services. However, VPLMN #1 1152-1 may support only the first slice service, and VPLMN #2 1152-2 may support only the second slice service. In this case, according to various embodiments, after registering with both VPLMN #1 1152-1 and VPLMN #2 1152-2, the terminal 1110 may receive the first slice service through VPLMN #1 1152-1 and receive the second slice service through the VPLMN #2 1152-2.

In the example of FIG. 11, although the terminal 1110 has subscribed to the second slice service through the HPLMN 1150, the HPLMN 1150 may not support the second slice service. In this case, according to another embodiment, after registering with both the HPLMN 1150 and the VPLMN (not shown) in the same area, the terminal 1110 may receive the first slice service through the HPLMN 1150 and receive the second slice service through the VPLMN (not shown).

That is, when the HPLMN 1150 alone may not simultaneously provide network slice services after the terminal 1110 subscribes to a plurality of different network slice services through the HPLMN 1150 or when the PLMN discovered in a state in which the terminal 1110 is out of the area of the HPLMN 1150 provides only some of the network slice services, to which the terminal has subscribed, the terminal 1110 may simultaneously receive the network slice services, to which it subscribed, through a plurality of PLMNs in a complex manner.

In order for the terminal to receive a plurality of network slice services using the plurality of PLMNs, the terminal shall register with the plurality of PLMNs. In other words, the UE shall simultaneously maintain registration on a plurality of PLMNs. Accordingly the present disclosure proposes various embodiments in which a terminal registers with all of two or more PLMNs.

In the following description, expressions such as registration on a network and connection/access to a network may be used interchangeably. The listed expressions mean an operation or a state in which a terminal enters a state in which a service may be provided in a corresponding network, and may also be described by other expressions having equivalent technical meanings.

Also, in the description below, the expression of registering a network slice may be used. This means an operation or state of entering a state in which a corresponding network slice service may be serviced to a terminal in a corresponding network, and may be described by other expressions having equivalent technical meanings.

According to an embodiment, a terminal searches for cells and networks available in a current area before performing a registration process, and selects a network (e.g., a first operator network) to perform the registration process according to a predetermined criterion. Thereafter, the terminal selects network slices to request registration on the corresponding network, and transmits a registration request message including corresponding network slice information. The network, which has received the registration request message, provides information on at least one network slice accepted to the terminal or information on at least one network slice which may be provided to the terminal by the network through a registration accept message, in consideration of the subscription information or other context information of the terminal.

In this case, when registration of all network slices requested by the terminal is not accepted, the terminal determines whether to attempt registration again through another network, for at least one non-accepted network slice. In addition, upon determining to request registration for the non-accepted network slice through another available network, the terminal may select a network (e.g., a second operator network) different from an initially selected network and a related cell, and transmit a registration request for the network slice(s) that has not yet been registered.

In the above-described process, when information indicating whether simultaneous access to or registration with a plurality of networks is allowed (hereinafter referred to as ‘multiple network access information’) is set to allow simultaneous access of the terminal, the terminal may perform operation for network slice registration through the second operator network. According to an embodiment, multiple network access information may be stored in a memory or a universal subscriber identification module (USIM) of a terminal in advance (e.g., when a terminal is manufactured or subscribes to HPLMH, etc.). According to another embodiment, the multiple network access information may be received by the terminal from the HPLMN or the first operator network.

Through the above process, the terminal may maintain registration on the first network and the second network at the same time. At this time, in order to independently manage signaling to the first network and context and signaling to the second network and context, an identifier for identifying the context related to the signaling connection to each network (hereinafter referred to as ‘network connection identifier’) is assigned, and the assigned identifier may be notified to the network. For example, when a terminal connects to or registers with the first network for the first time, a network connection identifier for the first network may be set to an arbitrary value (e.g., 0×10). Accordingly, when registering with the first network for the first time, the terminal transmits a registration request message including a network connection identifier set to an arbitrary value or a predefined value. Thereafter, when registering with the second network is additionally performed while maintaining registration with the first network, the terminal sets the network connection identifier to a value not used for the registered network (e.g. 0×11), and transmits a registration request message. According to an embodiment, a NAS connection ID may be used as the network connection identifier.

As described above, in a process in which the terminal transmits the registration request message, the terminal assigns the network connection identifier, and the terminal may transmit the network connection identifier through the registration request message. However, according to another embodiment, the network, which has received the registration request message from the terminal, may assign an identifier for connection to or registration with the terminal, that is, a network connection identifier. In this case, the terminal receives a registration accept message including a network connection identifier assigned by the network. The terminal may store the network connection identifier included in the registration accept message, and indicate a network related to signaling by using the corresponding network connection identifier whenever signaling such as connection to a network or NAS procedure occurs.

According to an embodiment, the terminal may simultaneously maintain registration on the first network and the second network, or may maintain registration on either the first network or the second network. In order to distinguish this, the terminal may transmit information indicating that an additional registration is requested to the network (e.g., the second next) in a state of having a context already created through another network (e.g., the first network) or currently registering with another network (e.g., the first network). For example, when transmitting a registration request in a state of not registering with any network, the terminal may transmit information indicating that it has not yet registered with another network or information indicating that it is first registration. As another example, in a state in which the terminal registers with a certain network, when the terminal wants to register with another network while maintaining the registration, the terminal may transmit information indicating that the terminal has registered with the other network and wants to establish an additional connection or to perform an additional registration.

According to an embodiment, the terminal associates a connection to each of a plurality of networks or context with a network connection identifier. In addition, the terminal associates each network connection identifier with network slice information accepted or registered by the corresponding network. Accordingly, when an event such as PDU session creation, release, data transmission, etc. occurs for a certain network slice, the terminal may identify the network connection identifier, network connection, or network associated with the related network slice, and transmit and receive signals through the identified network.

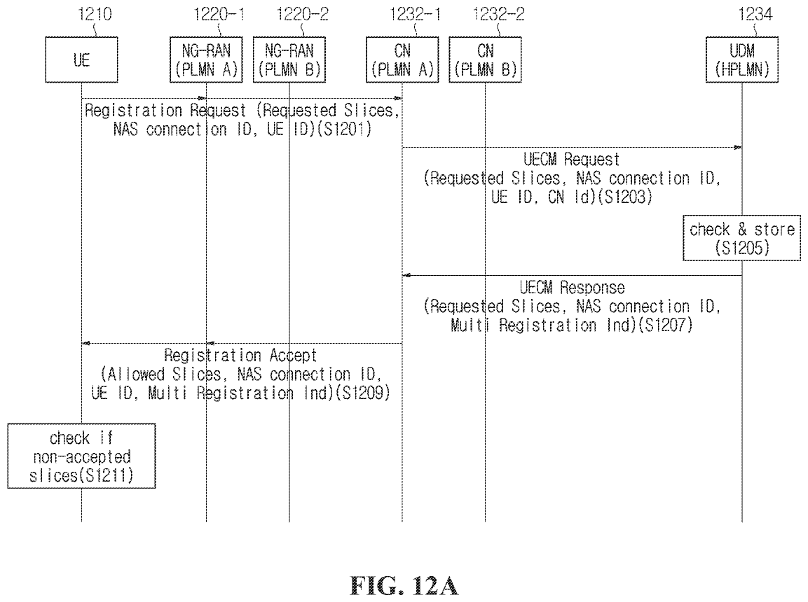

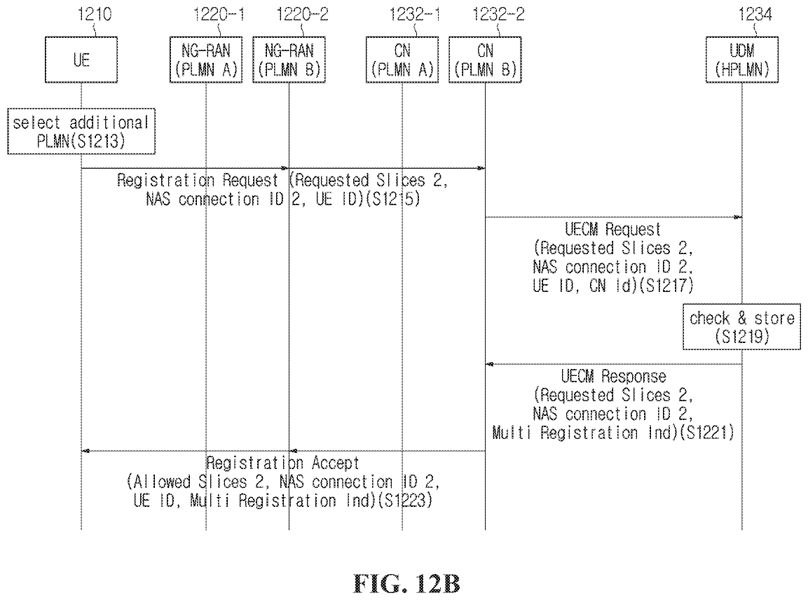

FIGS. 12A and 12B illustrate an example of a procedure for registration between a terminal and networks in a wireless communication system according to an embodiment of the present disclosure. FIGS. 12A and 12B show a case where a UE 1210 subscribes to a plurality of network slice services.

In step S1201, the UE 1210 first selects a PLMN A and transmits a registration request message to a NG-RAN 1220-1 of the PLMN A. The registration request message includes a list of network slices that the UE 1210 wants to receive (requested slices). In addition, the registration request message may further include at least one of an identifier (UE id) of the UE 1210 and a network connection identifier assigned by the UE 1210 (e.g., a NAS connection ID).

In step S1203, a CN 1232-1 (e.g., AMF) of the PLMN A transmits a UE context management (UECM) request message to a UDM 1234 of the HPLMN Specifically, after receiving the registration request message from the UE 1210, the CN 1232-1 may determine which network slices may be provided to the UE 1210, based on subscription information of the UE 1210, the context of the UE 1210, a network slice that may be provided by the PLMN A, etc. In addition, the CN 1232-1 transmits, to the UDM 1234, a UECM request message including information related to the network slice determined to be provided to the UE 1210, an identifier of the CN 1232-1 (e.g., AMF ID), and a network connection identifier provided from the UE 1210 (e.g., NAS connection ID). Accordingly, the UDM 1234 receives a request from the CN 1232-1 (e.g., AMF) that it controls the UE 1210.

In step S1205, the UDM 1234 checks whether there is a currently active or connected network node associated with the identifier of the UE 1210 based on the information received in step S1203. In other words, the UDM 1234 determines an identifier of a network node, e.g., AMF, currently stored in the UDM 1234 while being associated with the network connection identifier presented by the UE 1210 during the registration process. In addition, in relation to the UE 1210, in particular, with respect to the network connection identifier of the UE 1210, the UDM 1234 stores the identifier of the CN received in step S1203. At this time, although not shown in FIGS. 12A and 12B, if there is a previously stored CN identifier, the UDM 1234 may transmit an instruction to delete the context for the UE 1210 to the CN using the CN identifier.

In addition, in relation to the UE 1210, the UDM 1234 checks lists of network connection identifiers stored in the UE 1210 and information associated therewith. For example, when context information based on a plurality of network connection identifiers is present in the UE 1210 the UDM 1234 checks whether incompatible information is present for different connection identifiers. For example, in a situation in which slice #N and slice #M are associated with network connection identifier #2 in the UDM 1234, when the UE 1210 requests registration or approval of slice #N using network connection identifier #1 according to the preceding steps, the UDM 1234 may delete information of slice N previously associated with network connection identifier 42 and associate slice #/N only with network connection identifier #1, However, when the UE 1210 makes a request to exceed a maximum number of allowed network connections, that is, when the UE 1210 attempts to further use a new network connection identifier in a state of having as many network connection IDs as the maximum number of allowed network connections, the UDM 1234 may reject the registration request.

In step S1207, the UDM 1234 transmits a UECM response message (UE context management response message) to the CN 1220-1 (e.g., AMF). That is the UDM 1234 transmits a response to the request in step S1203 to the CN 1220-1. At this time, the UDM 1234 transmits a response message indicating whether registration based on the new network connection identifier requested by the UE 1210 is accepted or which network slice is accepted.

Additionally, the UDM 1234 may transmit information indicating whether the UE 1210 is capable to connect to a plurality of networks (hereinafter referred to as ‘multi-registration indicator’). The multi-registration indicator is information indicating whether or not the UE 1210 may register with a plurality of networks through one network, that is, a 3GPP access network. Context information generated when the UE 1210 subscribes to a communication service through the HPLMN may include information indicating whether multi-network registration is allowed for the UE 1210. Accordingly, the UDM 1234 may identify whether multi-network registration is accepted based on the context information generated upon subscription, and may transmit the multi-registration indicator. If multi-network registration is allowed and all network slice services desired by the UE 1210 are not provided by the currently accessed network, the UE 1210 may attempt additional network registration while maintaining registration on the currently accessed network. On the other hand, if multi-network connection is not allowed, the UE 1210 may not perform additional network registration on other networks even if all network slices desired thereby are not received from the currently accessed network.

In step S1209, the CN 1220-1 (e.g., AMF) transmits a registration accept message to the UE 1210 based on the information received in step S1211, In this case, the CN 1220-1 may report which network slice(s) has been accepted with respect to the network connection identifier associated with the accepted registration. That is, the registration accept message may include at least one of the accepted slice(s), a network connection identifier (e.g., NAS connection ID) an identifier of the UE 1210, or a multi-registration indicator.

In step S1211, the UE 1210 identifies whether all requested network slices are accepted. In other words, based on the information obtained in step S1209, the UE 1210 checks whether all network slices requested in step S1201 are accepted. That is, the UE 1210 identifies at least one non-accepted slice.

In step S1213, the UE 1210 searches for and selects another operator network (e.g., PLMN B) based on the determination result in step S1211. That is, when all of the network slices requested by the UE 1210 are not allowed in the current network (e.g., PLMN B) and access to a plurality of networks is allowed, the UE 1210 searches for and selects another network (e.g. PLMN B) in order to request the non-accepted network slice.

In step S1215, the UE 1210 transmits a registration request message to a NG-RAN 1220-2 of PLMN B. The UE 1210 performs a registration procedure to accept a network slice that has not yet been registered through the PLMN B. The registration request message may further include at least one of a list of network slices that the UE 1210 wants to receive, an identifier of the UE 1210, and a network connection identifier NAS connection ID) assigned by the UE 1210. At this time, the UE 1210 uses a network connection ID having a different value from the network connection ID used in step S1201.

In step S1217, the CN 2130-2 (e.g., AMF) of the PLMN B transmits a UECM request message to the UDM 1234 of the HPLMN. That is, the CN 2130-2 registers information of the UE 1210 in the UDM 1234 based on the request of the UE 1210 in step S1215. At this time, the CN 2130-2 transmits information on network slices allowed to the UE 1210 and a network connection identifier.

In step S1219, the UDM 1234 checks the request of the CN 2130-2 (e.g., AMF) based on the information in step S1217 and stores it. When multi-network connection is not allowed to the UE 1210, the UDM 1234 may reject the request of the AMF. For example, if the UE 1210 is currently active or has a valid connection, the UDM 1234 checks whether the active or valid connection and the request generated in step S1217 are compatible. Alternatively, if there is existing information associated with the same network connection identifier, the UDM 1234 updates the existing information with information newly received from the AMF. Alternatively, in the case of the request related to a new network connection identifier that has not been previously stored, the UDM 1234 stores a plurality of network connection identifiers and an identifier of a network node associated with each connection for the UE 1210.

In step S1221, the UDM 1234 transmits a UECM response message to the CN 1220-2 (e.g., AMF). In other words, the UDM 1234 allows the request in step S1217 and transmits a response. To this end, the UDM 1234 transmits a response message including whether the connection associated with the network connection identifier requested by the UE 1210 is accepted, or which network slice is allowed in relation thereto.

In step S1223, the CN 1220-2 transmits a registration accept message to the UE 1210. Through this, the CN 1220-2 transmits a network connection identifier (e.g., NAS connection ID 2), allowed network slice information, multi-registration identifier, etc. to the UE 1210 based on the information received in step S1221.

Then, although not shown in FIGS. 12A and 12B, in the process of requesting a PDU session for a new network slice, if the UE 1210 has a plurality of network connections, a PDU session establishment request is transmitted to a network in which the corresponding network slice is valid. Thereafter, the UE 1210 performs cell reselection and handover operations for each network. That is, the UE 1210 maintains MM and SM contexts for each connection, and performs an operation such as mobility update for each network connection.

In the embodiment described with reference to FIGS. 12A and 12B, as registration of all slices in PLMN A is not accepted, the UE 1210 requests the PLMN B to register at least one remaining slice. How-ever, according to another embodiment, the UE 1210 may divide slices to be used into two groups and request registration of some slice(s) from the PAIN A and registration of the remaining slice(s) from the PLMN B. That is, in an operation of registering with a plurality of networks, it is not essential to reject registration of some of the requested slices.

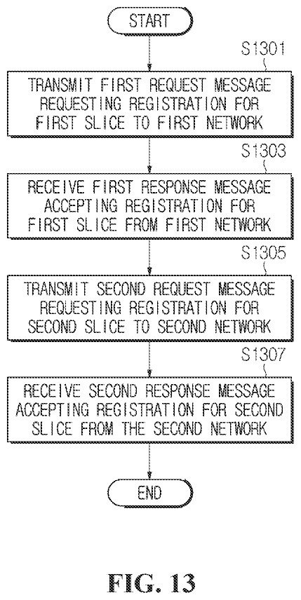

FIG. 13 illustrates an example of a procedure for network registration in a wireless communication system according to an embodiment of the present disclosure. FIG. 13 shows an operation method of a terminal (e.g., the UE 1210 of FIGS. 12A and 12B).

Referring to FIG. 13, in step S1301, the terminal transmits a first request message requesting registration for a first slice to a first network. Herein, the first request message includes at least one of information related to the first slice, a network connection identifier set to a first value assigned for the first network, or an identifier of the terminal. The network connection identifier is identification information for identifying registered networks during multiple network registration.

In step S1303, the terminal receives a first response message accepting registration for the first slice from the first network. Through this, the terminal may identify that the first slice is registered in the first network. The first response message may include at least one of information related to the accepted first slice, a network connection identifier set to a first value, an identifier of the terminal, and a multi-registration indicator.

In step S1305, the terminal transmits a second request message requesting registration for a second slice to a second network. That is, the terminal attempts to register the second slice not accepted by the first network in the second network. The second request message includes at least one of information related to the second slice, a network connection identifier set to a second value assigned for the second network, or an identifier of the terminal.

In step S1307, the terminal receives a second response message accepting registration for the second slice from the second core network node. Through this, the terminal may identify that the second slice is registered in the second network. The second response message may include at least one of information related to the accepted second slice, a network connection identifier set to a second value, an identifier of a terminal, and a multi-registration indicator.

According to the embodiment described with reference to FIG. 13, the terminal may have multiple registrations on a plurality of operator networks (e.g., a first network and a second network), and receive a first slice service and a second slice service through a plurality of operator networks. Accordingly, the terminal may receive or transmit first data traffic corresponding to the first slice through the first network and receive or transmit second data traffic corresponding to the second slice through the second network.

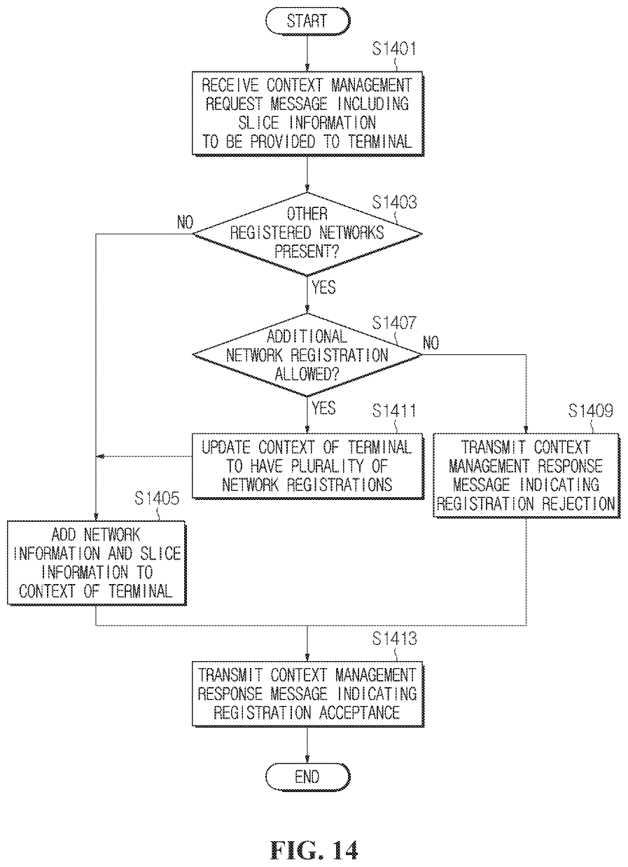

FIG. 14 illustrates an example of a procedure for managing information related to network registration in a wireless communication system according to an embodiment of the present disclosure. FIG. 14 shows an operation method of an apparatus (e.g., the UDM 1234 of FIGS. 12A and 12B) for managing context.

Referring to FIG. 14, in step S1401, the UDM receives a context management request message including information related to a slice to be provided to the terminal. That is, the UDM receives a request for registration of a slice to be provided by the corresponding network from a core network node (e.g., AMU of the network. The context management request message may include at least one of information related to the slice, a network connection identifier assigned to the network by the terminal, an identifier of the terminal, or an identifier of the core network node.

In step S1403, the UDM identifies whether there are other registered networks. In other words, the UDM identifies whether a terminal to receive a slice is already registered in a network different from the network to which the core network node that has transmitted the context management request message belongs.

If there is no other network in which the UE is registered, in step S1405, the UDM adds network-related information and slice-related information to the context of the UE. That is, the UDM accepts registration on the network to which the core network node that has transmitted the context management request message belongs. Thereafter, the UDM proceeds to step S1413.

On the other hand, if there is another network in which the terminal is registered, in step S1407, the UDM determines whether additional network registration is allowed for the terminal. For example, if multi-network registration is not allowed for the terminal, additional network registration is not allowed. The UDM may identify whether multi-network registration is allowed based on context information generated when the terminal subscribes to a communication service. Even if multi-network registration is allowed, when the number of requested registrations exceeds the maximum number of allowable registrations, no additional network registration is allowed. That is, when multi-network registration is allowed for the terminal, the maximum number of registrations that may be simultaneously maintained, that is, the maximum number of assignable network connection identifiers, may be defined. Accordingly, the UDM may determine whether additional network registration is allowed by identifying whether the number of networks in which the terminal is registered is less than the maximum number.

When additional network registration is not allowed, in step S1409, the UDM transmits a context management response message indicating registration rejection. That is, when multi-network registration is not allowed for the terminal or if it is already registered in the maximum number of networks, the UDM determines that additional network registration is not accepted for the terminal and transmits a context management response message indicating rejection of the request.

On the other hand, when additional network registration is allowed, in step S1411, the UDM updates the context of the terminal to have a plurality of network registrations. Specifically, the UDM adds information related to the new registration request made in this procedure to the context of the terminal. Accordingly, the terminal may use a plurality of slices through different operator networks. At this time, if there is registration on another network associated with the same value as the network connection indicator related to the request generated in this procedure, the UDM may delete information on the other network and instruct the other network to delete the context of the terminal.

In step S1413, the UDM transmits a context management response message indicating registration acceptance. The context management response message includes at least one of information related to the accepted slice, identification information of the terminal, or identification information of the core network node. Additionally, the context management response message may further include at least one of a network connection identifier or a multi-registration indicator.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on Whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

[Industrial Availability]

The embodiments of the present disclosure are applicable to various radio access systems. Examples of the various radio access systems include a 3^{rd} generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method of operating a user equipment (UE) in a wireless communication system, the method comprising:
transmitting a first request message requesting registration for a first slice to a first core network node of a first network;
receiving a first response message accepting registration for the first slice from the first core network node;
transmitting a second request message requesting registration for a second slice to a second core network node of a second network;
receiving a second response message accepting registration for the second slice from the second core network node; and
performing a first communication using the first slice and a second communication using the second slice based on multiple registrations by the first network and the second network.

2. The method of claim 1,
wherein the first request message includes a network connection identifier set to a first value assigned for the first network, and
wherein the second request message includes a network connection identifier set to a second value assigned for the second network.

3. The method of claim 1, wherein the first request message includes at least one of information related to the first slice, a network connection identifier set to a first value assigned for the first network or an identifier of the UE.

4. The method of claim 1, wherein the first response message includes a multi-registration indicator indicating being capable to register with a plurality of networks is possible.

5. The method of claim 1, further comprising:
receiving information indicating that the UE is allowed to be registered with a plurality of networks from a home public land mobile network (HPLMN) or the first network.

6. The method of claim 1, wherein the performing the first communication using the first slice and the second communication using the second slice comprises:
receiving or transmitting first data traffic corresponding to the first slice through the first network; and
receiving or transmitting second data traffic corresponding to the second slice through the second network.

7. The method of claim 1,
wherein the first request message requests registration for the second slice, and
wherein the first response message indicates that registration for the second slice in the first network is rejected.

8-16. (canceled)

17. A user equipment (UE) configured to operate in a wireless communication system, the UE comprising:
a transceiver;
at least one processor connected to the transceiver; and
at least one memory connected to the at least one processor and storing instructions that, based on being executed by the at least one processor, perform operations comprising:
transmitting a first request message requesting registration for a first slice to a first core network node of a first network;
receiving a first response message accepting registration for the first slice from the first core network node;
transmitting a second request message requesting registration for a second slice to a second core network node of a second network;
receiving a second response message accepting registration for the second slice from the second core network node; and
performing a first communication using the first slice and a second communication using the second slice based on multiple registrations by the first network and the second network.

18. The UE of claim 17, wherein the first request message includes a network connection identifier set to a first value assigned for the first network, and
wherein the second request message includes a network connection identifier set to a second value assigned for the second network.

19. The UE of claim 17, wherein the first request message includes at least one of information related to the first slice, a network connection identifier set to a first value assigned for the first network or an identifier of the UE.

20. The UE of claim 17, wherein the first response message includes a multi-registration indicator indicating being capable to register with a plurality of networks is possible.

21. The UE of claim 17, wherein the operations further comprise:
receiving information indicating that the UE is allowed to be registered with a plurality of networks from a home public land mobile network (HPLMN) or the first network.

22. The UE of claim 17, wherein the operations further comprise:
receiving or transmitting first data traffic corresponding to the first slice through the first network; and
receiving or transmitting second data traffic corresponding to the second slice through the second network.

23. The UE of claim 17, wherein the first request message requests registration for the second slice, and
wherein the first response message indicates that registration for the second slice in the first network is rejected.

24. An apparatus for providing a unified data management (UDM) function in a wireless communication system, the apparatus comprising:
a transceiver;
at least one processor coupled to the transceiver; and
at least one memory coupled to the at least one processor and storing instructions that, based on being executed by the at least one processor, perform operations comprising:
receiving a request message including information related to a slice to be provided to a user equipment (UE) registered with a first network from a second network;
updating context of the UE such that the UE has registration on the first network and registration on the second network; and
transmitting a response message indicating acceptance of registration on the second network.

25. The apparatus of claim 24, wherein the first network corresponds to a network connection identifier set to a first value assigned for the first network by the UE, and
wherein the request message includes a network connection identifier set to a second value assigned for the second network by the UE.

26. The apparatus of claim 25, wherein the operations further comprise:
accepting both registration on the first network and registration on the second network based on the second value being different from the first value.

27. The apparatus of claim 24, wherein the operations further comprise:
identifying information indicating that the UE is capable to register with a plurality of networks.

28. The apparatus of claim 24, wherein the response message includes at least one of information related to a slice accepted to be provided to the UE by the second network, identification information of the UE, a network connection identifier assigned for the second network or a multi-registration indicator.
